(19) United States
(12) Patent Application Publication
(10) Pub. No.: US 2023/0038640 A1
(43) Pub. Date: Feb. 9, 2023

(54) Method for calculating service life of material under action of thermal shock load

(71) Applicant: Nanjing University of Aeronautics and Astronautics, Nanjing (CN)

(72) Inventors: Zhigang Sun, Nanjing (CN); Yingdong Song, Nanjing (CN); Rutao Zhao, Nanjing (CN); Xuming Niu, Nanjing (CN); Yaning Chang, Nanjing (CN)

(73) Assignee: Nanjing University of Aeronautics and Astronautics, Nanjing (CN)

(21) Appl. No.: 17/956,876

(22) Filed: Sep. 30, 2022

(30) Foreign Application Priority Data
Sep. 30, 2021 (CN) 202111157185.3

(51) Int. Cl. G06F 30/20

(52) U.S. Cl. CPC G06F 30/20; G06F 2111/10

(57) ABSTRACT

The present disclosure discloses a method for calculating the service life of a material under the action of a thermal shock load. The method includes steps of obtaining test results at different thermal shock temperatures and a thermal shock cycle number according to a thermal shock test, and calculating a temperature rise rate to temperature drop rate ratio Rᵥ; calculating a corresponding stress intensity factor ΔK according to a crack length a measured in the test; calculating a thermal stress σ at the notch and a notch stress concentration coefficient kₜ of the test specimen; calculating a stress intensity factor threshold ΔKₜₕ according to the crack length a measured in the test; and substituting the obtained the stress intensity factor ΔK, stress intensity factor threshold ΔKₜₕ and temperature rise rate to temperature drop rate ratio Rᵥ into a thermal fatigue crack growth model.

### TECHNICAL FIELD

The present disclosure relates to a method for calculating a service life of a material under the action of a thermal shock load, and belongs to the technical field of high-temperature structural strength.

### BACKGROUND

In an actual usage of an aero-engine, a high-temperature flowpath components such as a turbine blade and a combustor will be subjected to a thermal shock load due to thechange of working state of the aero-engine. As a temperature field changes and deforms, thehot-end componentsare restrained and will generate a thermal stress that changes with a change in a temperature load. Furthermore, a maximum thermal stress usually appears when the state of the engine changes. At this time, temperature difference between the inside and outside of a component is large, and the temperature field distribution is relatively inhomogeneous. Compared with a temperature field in which the engine is in a under stable working state, a temperature field in a transition state becomes a transient temperature field. During analysis of the thermal shock performance of high-temperature component, it is necessary to calculate a corresponding thermal stress according to the transient temperature field. In order to quantitatively represent the damage caused by a thermal shock load to aero-engine components and to explore life changes of a high-temperature alloy material under the action of a thermal shock load, it is necessary to establish a relationship model among a thermal shock crack length, a thermal shock temperature, and cycle number.

The thermal shock fatigue of materials and structures is a low-cycle fatigue (LCF) caused by temperature changes. A Manson-Coffin model is mostly used among traditional LCF life analysis methods. In this model, the life of a component is usually estimated according to the local stress-strain history of a dangerous portion of the component. According to a basic assumption, if the maximum stress-strain history of the dangerous portion of a structural member made of the same material is the same as the stress-strain history of a smooth test specimen, their fatigue life will be the same. In engineering practice, since the temperature of the high-temperature component of the aero-engine is relatively high, it is difficult to test the stress and strain of the dangerous portion by external test equipment. Furthermore, this model cannot fully characterize a dynamic change relationship among the thermal fatigue crack, the thermal shock temperature, and the cycle number generated by the component under the action of the thermal shock load in the thermal shock process, so that later researches on the microscopic damage caused by the thermal shock to the construction will lack a dynamic evolution process of the damage to microstructures.

### SUMMARY

The present disclosure aims to provide a method for calculating the service life of a material under the action of a thermal shock load, which can fully characterize a dynamic change relationship among the thermal fatigue crack, the thermal shock temperature, and the cycle number generated by a component under the action of a thermal shock load in a thermal shock process.

In order to achieve the foregoing objective, the present disclosure adopts the following technical solution:

A method for calculating the service life of a material under the action of a thermal shock load is provided. A thermal shock life calculation model based on crack growth is established by associating a thermal shock crack length a with a thermal shock temperature T, a thermal shock rate ratio Rᵥ and a thermal shock cycle number N:

$$\left(\frac{d a}{d N}\right) = C {\left(\frac{4 \sqrt{2}}{{\left(1 - R {R}_{v}\right)}^{n} E \text{} ' \left(1 - 2 v\right) {σ}_{y s}}\right)}^{m} \left(Δ {K}^{2 m} - Δ {K}_{t h}^{2 m}\right)$$

where da/dN is a thermal shock crack growth rate; C, n and m are material constants related to a thermal shock temperature; R is a thermal stress ratio; v is a Poisson’s ratio of the material; Rᵥ is a temperature rise rate to temperature drop rate ratio in a thermal shock process; E′ is an elastic modulus, E′=E/(1-v²); σ_{ys} is a yield stress of the material; ΔK is a stress intensity factor related to the thermal shock temperature; ΔKₜₕ is a stress intensity factor threshold; formula (1) is integrated to obtain a thermal fatigue life change calculation model with respect to crack growth:

$${\int }_{{N}_{i}}^{N} d N = {\int }_{{a}_{i}}^{a} \frac{1}{C {\left(\frac{4 \sqrt{2}}{{\left(1 - R {R}_{v}\right)}^{n} E ' \left(1 - 2 v\right) {σ}_{y s}}\right)}^{m} \left(Δ {K}^{2 m} - Δ {K}_{t h}^{2 m}\right)} d a$$

where aᵢ is an initiation size of a crack; Nᵢ is an initiation life of the crack.

The method for calculating the service life of a material under the action of a thermal shock load includes the following steps:
(1) carrying out a thermal shock test on a standard thermal fatigue specimen under different test conditions, and establishing an a-N relational graph according to test results obtained in the thermal shock test at different thermal shock temperatures and a thermal shock cycle number;
(2) calculating the temperature rise rate to temperature drop rate ratio Rᵥ according to a change in the temperature at a notch of the test specimen in the thermal shock test process in step (1);
(3) establishing a relationship between the stress intensity factor ΔK and the crack length a according to the a-N relationship in step (1):
$$Δ K = \frac{{σ}_{max} - {k}_{t} {C}_{c l}}{\sqrt{1 + 4.5 \left(a / \text{} ρ\right)}} \sqrt{π \frac{{a}^{α} {\left({a}_{s} - a\right)}^{\left(1 - α\right)}}{Q} F \left(\frac{c}{t} , \frac{c}{a} , \frac{a}{b} Φ\right)}$$
where kₜ is a stress concentration coefficient at the notch of the test specimen; σₘₐₓ is a maximum thermal stress in a test area of the test specimen; σ_{cl} is the closure stress of a thermal shock crack; p is a radius of the root of the notch of the test specimen; Q is a shape correction factor; α is a thermal fatigue crack growth influence factor; aₛ is a crack arrest size of the thermal shock crack; F is a boundary condition; c is a depth of the thermal shock crack; t is a thickness of the test specimen; b is a width of the test specimen; Φ is an angular function of an elliptical crack tip;
(4) calculating a notch thermal stress σ and a notch stress concentration coefficient kₜ of the test specimen under thermal shock test conditions by using finite element software;
(5) calculating a relationship between the stress intensity factor threshold ΔKₜₕ and the crack length a according to the test results in step (1):
$$Δ {K}_{t h} = {\left(\frac{a}{a - d}\right)}^{1 / 2} Δ {σ}_{e R} \sqrt{π d}$$
where d is a microscopic crack size limit of the material; σ_{eR} is an ordinary fatigue limit of the material; and
(6) substituting formulas (3) and (4) into formula (2) for integration to obtain a thermal fatigue life calculation model based on crack growth.

In formula (1), the temperature rise rate to temperature drop rate ratio Rᵥ in the thermal shock process on the right side of the equal sign is closely related to the test conditions in the thermal shock process, and the size of Rᵥ reflects the severity of thermal shock.

In formula (1), the stress intensity factor ΔK on the right of the equal sign reflects the magnitude of a driving force for fatigue crack growth in the thermal shock process, and is closely related to the temperature in the thermal shock process, a crack length, and a shape of the test specimen.

In formula (1), the stress intensity factor threshold ΔKₜₕ on the right side of the equal sign reflects the size of an obstacle to be overcome in the thermal shock crack growth process, and is related to the fatigue crack length and properties of the material.

In step (1), a relationship among temperature rise and drop time of the test specimen under different thermal shock conditions, a change in the temperature at the notch of the test specimen, the thermal shock crack length a, and the thermal shock cycle number N is determined by means of carrying out thermal shock tests under different test conditions.

In step (2), the temperature rise rate to temperature drop rate ratio Rᵥ is calculated according to the temperature at the notch of the test specimen in the thermal shock test process in step (1), and an expression is as follows:

$${R}_{v} = \frac{{v}_{H}}{{v}_{C}}$$

where v_{H} is a temperature rise rate, and v_{c} is a temperature drop rate.

in step (3), in the relationship between the stress intensity factor threshold ΔKₜₕ and the crack length a, the closure stress σcl, the crack arrest size as of the crack and the depth c of the crack are determined according to the test results in step (1), and expressions of the shape correction factor Q and the boundary condition F are as follows:

$$Q = 1 + 1.46 {\left(\frac{2 c}{a}\right)}^{1.65}$$

$$F = \left(1.04 + 0.2 {\left(\frac{a}{2 t}\right)}^{2} - 0.106 {\left(\frac{a}{2 t}\right)}^{4}\right) \left(1.1 + 0.35 {\left(\frac{a}{2 t}\right)}^{2}\right)$$

In step (4), the same test conditions are set in the finite element analysis according to a temperature change and thermal shock time of a test area in the thermal shock test process in step (1), so as to ensure that an obtained thermal stress change and temperature change are consistent with those in a real test; transient thermal-mechanical coupling analysis is performed, on the basis of a transient thermal module and a transient structural module in the NASYS software, on the standard fatigue test specimen model used in step (1), thus determining the change in the thermal stress at the notch of the test specimen and the notch stress concentration coefficient kₜ; and an expression is as follows:

$${k}_{t} = \frac{{σ}_{max}}{{σ}_{0}}$$

where σₘₐₓ is the maximum stress at a stress concentration portion; and σ₀ is a nominal stress.

In step (5), in the relationship between the stress intensity factor threshold ΔKₜₕ and the crack length a, the microscopic crack size limit d of the material is obtained according to a grain size of the material or a micro defect size of the material and the ordinary fatigue limit σ_{eR} of the material through an S-N curve of the material or obtained by carrying out a fatigue test.

In step (6), the stress intensity factor ΔK in formula (3), the stress intensity factor threshold ΔKₜₕ in formula (4), and the temperature rise rate to temperature drop rate ratio Rᵥ calculated in step (2) are substituted into formula (2) for integration, thus obtaining the thermal shop fatigue life calculation model based on crack growth.

Beneficial effects: In the present disclosure, a function relationship between a thermal fatigue crack growth rate and a stress intensity factor is established, and a temperature rise rate to temperature drop rate ratio in the thermal shock process is introduced into the function relationship, so as to characterize the severity of the thermal shock. Furthermore, for the characteristics of the thermal fatigue crack growth, a thermal fatigue crack arrest size is introduced into the relational expression of the stress intensity factor. This is a method for calculating the service life considering relevant conditions in the thermal shock process.

### BRIEF DESCRIPTION OF THE DRAWINGS

FIG. 1 is a flow chart of a specific implementation according to the present disclosure;

FIG. 2 is a diagram of a change of a temperature at a notch in a thermal shock process;

FIG. 3 is a diagram of changes in a temperature rise rate and a temperature drop rate at a notch in a thermal shock process; and

FIG. 4 is a schematic diagram of stress concentration at a notch of a test specimen.

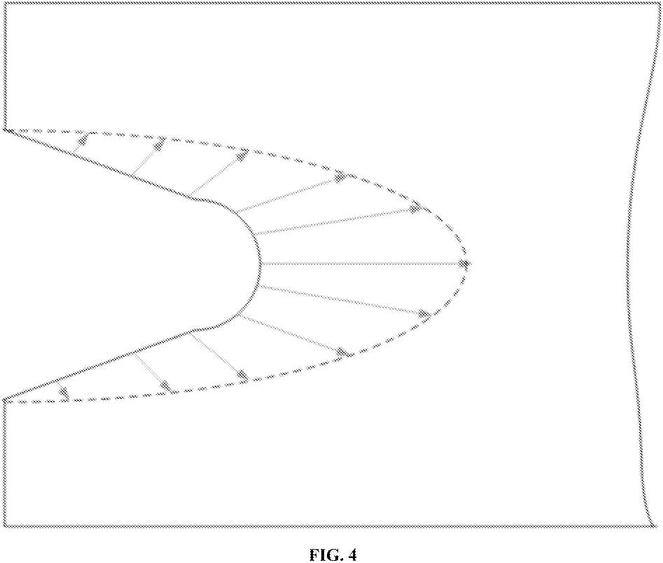

### DETAILED DESCRIPTION OF THE EMBODIMENTS

The present disclosure is further described below in combination with the accompanying drawings and embodiments.

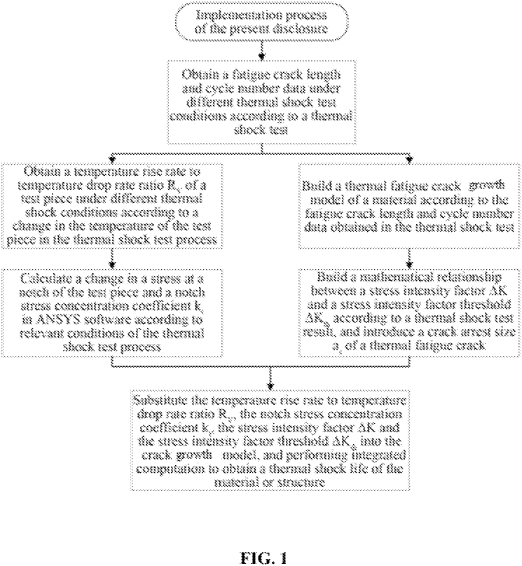

As shown in FIG. 1, a method for calculating the service life of a material under the action of a thermal shock load is provided. A thermal shock life calculation model based on crack growth is established by associating a thermal shock crack length a with a thermal shock temperature T, a thermal shock rate ratio Rᵥ and a thermal shock cycle number N:

$$\left(\frac{d a}{d N}\right) = C {\left(\frac{4 \sqrt{2}}{{\left(1 - R {R}_{v}\right)}^{n} {E}^{'} \left(1 - 2 v\right) {σ}_{y s}}\right)}^{m} \left(Δ {K}^{2 m} - {Δ K}_{t h}^{2 m}\right)$$

where da/dN is a thermal shock crack growth rate; C, n and m are material constants related to a thermal shock temperature; R is a thermal stress ratio; v is a Poisson’s ratio of the material; Rᵥ is a temperature rise rate to temperature drop rate ratio in a thermal shock process; E′ is an elastic modulus, E′=E/(1-v²); σ_{ys} is a yield stress of the material; ΔK is a stress intensity factor related to the thermal shock temperature; ΔKₜₕ is a stress intensity factor threshold;

formula (1) is integrated to obtain a thermal fatigue life change calculation model with respect to crack growth:

$${\int }_{{N}_{1}}^{N} d N = {\int }_{a 1}^{a} \frac{1}{C {\left(\frac{4 \sqrt{2}}{{\left(1 - R {R}_{v}\right)}^{n} {E}^{'} \left(1 - 2 v\right) {σ}_{y s}}\right)}^{m} \left(Δ {K}^{2 m} - Δ {K}_{t h}^{2 m}\right)} d a$$

where aᵢ is an initiation size of a crack; Nᵢ is an initiation life of the crack.

In formula (1), the temperature rise rate to temperature drop rate ratio Rᵥ in the thermal shock process on the right side of the equal sign is closely related to the test conditions in the thermal shock process, and the size of Rᵥ reflects the severity of thermal shock; the stress intensity factor ΔK on the right of the equal sign reflects the magnitude of a driving force for fatigue crack growth in the thermal shock process, and is closely related to the temperature in the thermal shock process, a crack length, and a shape of the test specimen;the stress intensity factor threshold ΔKₜₕ on the right side of the equal sign reflects the size of an obstacle to be overcome in the thermal shock crack growth process, and is related to the fatigue crack length and properties of the material.

The method for calculating the service life of a material under the action of a thermal shock load includes the following steps:
(1) a thermal shock test is carried out on a standard thermal fatigue test specimen under different test conditions, and an a-N relational graph is established according to test results obtained in the thermal shock test at different thermal shock temperatures and a thermal shock cycle number;
(2) the temperature rise rate to temperature drop rate ratio Rv is calculated according to a change in the temperature at a notch of the test specimen in the thermal shock test process in step (1);
(3) a relationship between the stress intensity factor ΔK and the crack length a is established according to the a-N relationship in step (1):
$$Δ K = \frac{{σ}_{max} - {k}_{t} {c}_{c l}}{\sqrt{1 + 4.5 \left(a / p\right)}} \sqrt{π \frac{{a}^{a} {\left({a}_{s} - a\right)}^{\left(1 - a\right)}}{Q} F \left(\frac{c}{t} , \frac{c}{a} , \frac{a}{b} , Φ\right)}$$
where kₜ is a stress concentration coefficient at the notch of the test specimen; σₘₐₓ is a maximum thermal stress in a test area of the test specimen; σ_{cl} is the closure stress of a thermal shock crack; p is a radius of the root of the notch of the test specimen; Q is a shape correction factor; α is a thermal fatigue crack growth influence factor; aₛ is a crack arrest size of the thermal shock crack; F is a boundary condition; c is a depth of the thermal shock crack; t is a thickness of the test specimen; b is a width of the test specimen; Φ is an angular function of an elliptical crack tip;
(4) a notch thermal stress σ and a notch stress concentration coefficient kₜ of the test specimen under thermal shock test conditions are calculated by using finite element software;
(5) a relationship between the stress intensity factor threshold ΔKₜₕ and the crack length a is calculated according to the test results in step (1):
$$Δ {K}_{t h} = {\left(\frac{a}{a - d}\right)}^{1 / 2} Δ {σ}_{e R} \sqrt{π d}$$
where d is a microscopic crack size limit of the material; σe_{R} is an ordinary fatigue limit of the material; and
(6) formulas (3) and (4) are substituted into formula (2) for integration to obtain a thermal fatigue life calculation model based on crack growth.

In step (1), a relationship among temperature rise and drop time of the test specimen under different thermal shock conditions, a change in the temperature at the notch of the test specimen, the thermal shock crack length a, and the thermal shock cycle number N is determined by means of carrying out thermal shock tests under different test conditions.

In step (2), the temperature rise rate to temperature drop rate ratio Rᵥ is calculated according to the temperature at the notch of the test specimen in the thermal shock test process in step (1), and an expression is as follows:

$${R}_{v} = \frac{{v}_{H}}{{v}_{C}}$$

where v_{H} is a temperature rise rate, and v_{c} is a temperature drop rate.

In step (3), in the relationship between the stress intensity factor threshold ΔKₜₕ and the crack length a, the closure stress σcₗ, the crack arrest size as of the crack and the depth c of the crack are determined according to the test results in step (1), and expressions of the shape correction factor Q and the boundary condition F are as follows:

$$Q = 1 + 1.46 {\left(\frac{2 c}{a}\right)}^{1.65}$$

$$F = \left(1.04 + 0.2 {\left(\frac{a}{2 t}\right)}^{2} - 0.106 {\left(\frac{a}{2 t}\right)}^{4}\right) \left(1.1 + 0.35 {\left(\frac{a}{2 t}\right)}^{2}\right)$$

In step (4), the same test conditions are set in the finite element analysis according to a temperature change and thermal shock time of a test area in the thermal shock test process in step (1), so as to ensure that an obtained thermal stress change and temperature change are consistent with those in a real test; transient thermal-mechanical coupling analysis is performed, on the basis of a transient thermal module and a transient structural module in the NASYS software, on the standard fatigue test specimen model used in step (1), thus determining the change in the thermal stress at the notch of the test specimen and the notch stress concentration coefficient kₜ; and an expression is as follows:

$${k}_{t} = \frac{{σ}_{max}}{{σ}_{0}}$$

where σₘₐₓ is the maximum stress at a stress concentration portion; and σ₀ is a nominal stress.

In step (5), in the relationship between the stress intensity factor threshold ΔKₜₕ and the crack length a, the microscopic crack size limit d of the material is obtained according to a grain size of the material or a micro defect size of the material and the ordinary fatigue limit σ_{eR} of the material through an S-N curve of the material or obtained by carrying out a fatigue test.

In step (6), the stress intensity factor ΔK in formula (3), the stress intensity factor threshold ΔKₜₕ in formula (4), and the temperature rise rate to temperature drop rate ratio Rᵥ calculated in step (5) are substituted into formula (2) for integration, thus obtaining the thermal shop fatigue life calculation model based on crack growth.

The present disclosure is further described below in combination with specific embodiments.

### Embodiment

In this embodiment, calculation of a thermal shock fatigue life of a GH4169 high-temperature alloy material is taken as an example, including the following steps:

Step (1), a thermal shock test was carried out on a standard GH4169 thermal fatigue test specimen at 600° C., 650° C. and 700° C.; the test specimen was ground and polished using sand paper of 2000 meshes respectively when thermal shock cycle numbers are 100, 500, 1000, 2000, 3000, 5000, 7000, and 9000; and a thermal fatigue crack length a was then measured under an optical microscope to obtain a-N curves at different thermal shock temperatures, and the a-N curves were treated to obtain a curve

$$\frac{d a}{d N} - a .$$

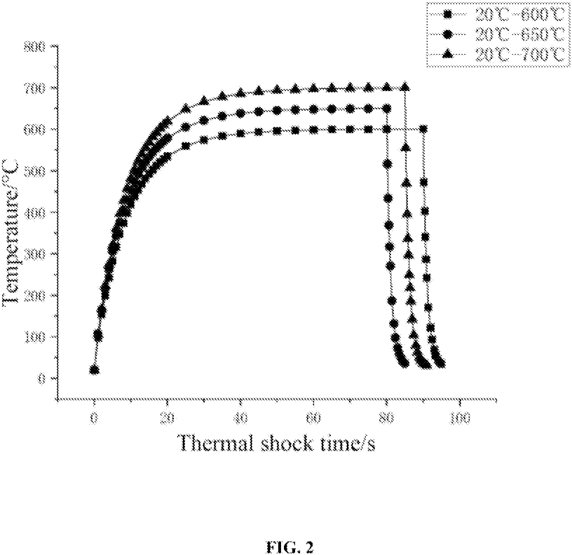

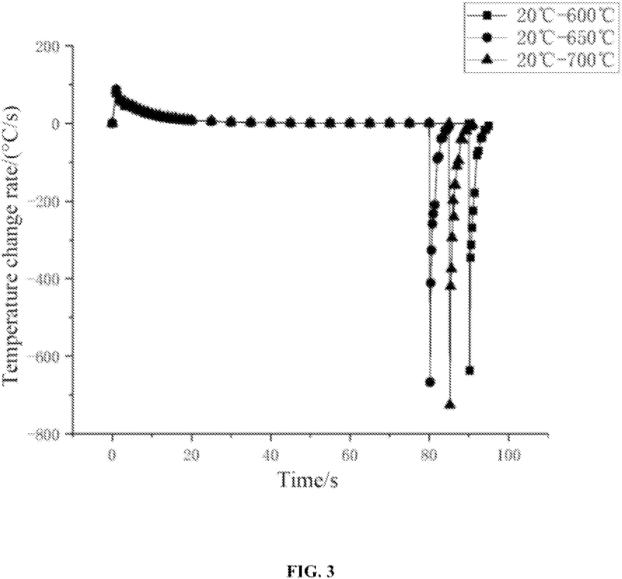

Step (2), in the thermal shock test process, a change of the temperature at a notch of the test specimen was obtained as shown in FIG. 2; the temperature data in FIG. 2 was processed to obtain a diagram of a temperature rise rate and a temperature drop rate at the notch of the test specimen, as shown in FIG. 3; and a temperature rise rate to temperature drop rate ratio Rᵥ in the thermal shock process was calculated according to formula (5).

Step (3), the same test conditions were set in the finite element analysis according to a temperature change and thermal shock time of a test area in the thermal shock test process in step (1), so as to ensure that an obtained thermal stress change and temperature change were consistent with those in a real test; transient thermal-mechanical coupling analysis was performed, on the basis of a transient thermal module and a transient structural module in the NASYS software, on the standard fatigue test specimen model used in step (1), thus determining the change in the thermal stress at the notch of the test specimen and the notch stress concentration coefficient kₜ.

Step (4), the thermal shock crack length a, the depth c of the crack, and the width b and thickness t of the thermal shock test specimen which were obtained in step (1) weresubstituted into formulas (6) and (7) to obtain a shape correction factor Q and a boundary condition F.

Step (5), the thermal stress at the notch of the test specimen and the stress concentration coefficient kt obtained in step (3), the shape correction factor Q and boundary condition F obtained in step (4), and the crack length a measured in step (1) were substituted into formula (3) to obtain a relationship curve between the stress intensity factor ΔK and the crack length a

Step (6), the microscopic crack size limit d of the material was the grain size of the material, and an ordinary fatigue limit σ_{eR} was obtained from the S-N curve of the material; and a relationship curve between the stress intensity factor threshold ΔKₜₕ and the crack length a is obtained according to the thermal fatigue crack length a measured in step (1).

Step (7), the temperature rise rate to temperature drop rate ratio Rᵥ obtained in step (2), the stress intensity factor ΔK obtained in step (5) and the stress intensity factor threshold ΔKₜₕ obtained in step (6) are substituted into formula (2) for integration, thus obtaining a thermal shock fatigue crack life calculation model based on crack growth.

The above describes only the preferred embodiments of the present disclosure. It should be noted that those of ordinary skill in the art can further make several improvements and retouches without departing from the principles of the present disclosure. These improvements and retouches shall all fall within the protection scope of the present disclosure.

What is claimed is:

1. A method for calculating the service life of a material under the action of a thermal shock load, wherein a thermal shock life calculation model based on crack growth is established by associating a thermal shock crack length a with a thermal shock temperature T, a thermal shock rate ratio Rᵥ and a thermal shock cycle number N:
$$\left(\frac{d a}{d N}\right) = C {\left(\frac{4 \sqrt{2}}{{\left(1 - R {R}_{v}\right)}^{n} {E}^{'} \left(1 - 2 v\right) {σ}_{y s}}\right)}^{m} \left(Δ {K}^{2 m} - Δ {K}_{t h}^{2 m}\right)$$
where da/dN is a thermal shock crack growth rate; C, n and m are material constants related to a thermal shock temperature; R is a thermal stress ratio; v is a Poisson’s ratio of the material; Rᵥ is a temperature rise rate to temperature drop rate ratio in a thermal shock process; E′ is an elastic modulus,
$${E}^{'} = E / \left(1 - {v}^{2}\right)$$
is a yield stress of the material; ΔK is a stress intensity factor related to the thermal shock temperature; ΔKₜₕ is a stress intensity factor threshold;
formula (1) is integrated to obtain a thermal fatigue life change calculation model with respect to crack growth:
$${\int }_{{N}_{1}}^{\begin{matrix} \\ N\end{matrix}} d N = {\int }_{{a}_{1}}^{a} \frac{1}{C {\left(\frac{4 \sqrt{2}}{{\left(1 - R {R}_{v}\right)}^{n} {E}^{'} \left(1 - 2 v\right) {σ}_{y s}}\right)}^{m} \left(Δ {K}^{2 m} - Δ {K}_{t h}^{2 m}\right)} d a$$
where aᵢ is an initiation size of a crack; Nᵢ is an initiation life of the crack;
the method for calculating the service life of the material under the action of the thermal shock load comprises the following steps:
S1 carrying out a thermal shock test on a standard thermal fatigue test specimen under different test conditions, and establishing an a-N relational graph according to test results obtained in the thermal shock test at different thermal shock temperatures and a thermal shock cycle number;
S2 calculating the temperature rise rate to temperature drop rate ratio Rᵥ according to a change in the temperature at a notch of the test specimen in the thermal shock test process in step (1);
S3 establishing a relationship between the stress intensity factor ΔK and the crack length a according to the a-N relationship in step (1):
$$Δ K = \frac{{σ}_{max} - {k}_{t} {c}_{c l}}{\sqrt{1 + 4.5 \left(a / \text{} ρ\right)}} \sqrt{π \frac{{a}^{a} {\left({a}_{s} - a\right)}^{\left(1 - α\right)}}{Q}} F \left(\frac{c}{t} , \frac{c}{a} , \frac{a}{b} , Φ\right)$$
where kₜ is a stress concentration coefficient at the notch of the test specimen; σₘₐₓ is a maximum thermal stress in a test area of the test specimen; σ_{cl} is the closure stress of a thermal shock crack; ρ is a radius of the root of the notch of the test specimen; Q is a shape correction factor; α is a thermal fatigue crack growth influence factor; as is a crack arrest size of the thermal shock crack; F is a boundary condition; c is a depth of the thermal shock crack; t is a thickness of the test specimen; b is a width of the test specimen; Φ is an angular function of an elliptical crack tip;
S4 calculating anotch thermal stress σ and a notch stress concentration coefficient kₜ of the test specimen under thermal shock test conditions by using finite element software;
S5 calculating a relationship between the stress intensity factor threshold ΔKₜₕ and the crack length a according to the test results in step (1):
$$Δ {K}_{t h} = {\left(\frac{a}{a - d}\right)}^{1 / 2} Δ {σ}_{e R} \sqrt{π \text{} d}$$
where d is a microscopic crack size limit of the material; σ_{eR} is an ordinary fatigue limit of the material; and
S6 substituting formulas (3) and (4) into formula (2) for integration to obtain a thermal fatigue life calculation model based on crack growth.

2. The method for calculating the service life of the material under the action of the thermal shock load according to claim 1, wherein in formula (1), the temperature rise rate to temperature drop rate ratio Rᵥ in the thermal shock process on the right side of the equal sign is closely related to the test conditions in the thermal shock process, and the size of Rᵥ reflects the severity of thermal shock.

3. The method for calculating the service life of the material under the action of the thermal shock load according to claim 1, wherein in formula(1), the stress intensity factor AK on the right of the equal sign reflects the magnitude of a driving force for fatigue crack growth in the thermal shock process, and is closely related to the temperature in the thermal shock process, a crack length, and a shape of the test specimen.

4. The method for calculating the service life of the material under the action of the thermal shock load according to claim 1, wherein in formula (1), the stress intensity factor threshold ΔKₜₕ on the right side of the equal sign reflects the size of an obstacle to be overcome in the thermal shock crack growth process, and is related to the fatigue crack length and properties of the material.

5. The method for calculating the service life of the material under the action of the thermal shock load according to claim 1, wherein in step (1), a relationship among temperature rise and drop time of the test specimen under different thermal shock conditions, a change in the temperature at the notch of the test specimen, the thermal shock crack length a, and the thermal shock cycle number N is determined by means of carrying out thermal shock tests under different test conditions.

6. The method for calculating the service life of the material under the action of the thermal shock load according to claim 1, wherein in step (2), the temperature rise rate to temperature drop rate ratio Rᵥ is calculated according to the temperature at the notch of the test specimen in the thermal shock test process in step (1), and an expression is as follows:
$${R}_{v} = \frac{{v}_{H}}{{v}_{C}}$$
where v_{H} is a temperature rise rate, and vc is a temperature drop rate.

7. The method for calculating the service life of the material under the action of the thermal shock load according to claim 1, wherein in step (3), in the relationship between the stress intensity factor threshold ΔKₜₕ and the crack length a, the closure stress σ_{cl}, the crack arrest size as of the crack and the depth c of the crack are determined according to the test results in step(1), and expressions of the shape correction factor Q and the boundary condition F are as follows:
$$Q = 1 + 1.46 {\left(\frac{2 c}{a}\right)}^{1.65}$$
$$F = \left(1.04 + 0.2 {\left(\frac{a}{2 t}\right)}^{2} - 0.106 {\left(\frac{a}{2 t}\right)}^{4}\right) \left(1.1 + 0.35 {\left(\frac{a}{2 t}\right)}^{2}\right)$$
.

8. The method for calculating the service life of the material under the action of the thermal shock load according to claim 1, wherein in step (4), the same test conditions are set in the finite element analysis according to a temperature change and thermal shock time of a test area in the thermal shock test process in step (1), so as to ensure that an obtained thermal stress change and temperature change are consistent with those in a real test; transient thermal-mechanical coupling analysis is performed, on the basis of a transient thermal module and a transient structural module in the NASYS software, on the standard fatigue test specimen model used in step (1), thus determining the change in the thermal stress at the notch of the test specimen and the notch stress concentration coefficient kₜ; and an expression is as follows:
$${k}_{t} = \frac{{σ}_{max}}{{σ}_{0}}$$
where σₘₐₓ is the maximum stress at a stress concentration portion; and σ₀ is a nominal stress.

9. The method for calculating the service life of the material under the action of the thermal shock load according to claim 1, wherein in step (5), in the relationship between the stress intensity factor threshold ΔKₜₕ and the crack length a, the microscopic crack size limit d of the material is obtained according to a grain size of the material or a micro defect size of the material and the ordinary fatigue limit σ_{eR} of the material through an S-N curve of the material or obtained by carrying out a fatigue test.

10. The method for calculating the service life of the material under the action of the thermal shock load according to claim 1, wherein in step (6), the stress intensity factor ΔK in formula (3), the stress intensity factor threshold ΔKₜₕ in formula (4), and the temperature rise rate to temperature drop rate ratio Rᵥ calculated in step (2) are substituted into formula (2) for integration, thus obtaining the thermal shop fatigue life calculation model based on crack growth.
